(19) United States
(12) Patent Application Publication
(10) Pub. No.: US 2002/0131167 A1
(43) Pub. Date: Sep. 19, 2002

(54) Sample holder for an imaging system

(76) Inventors: Francis T. Nguyen, San Diego, CA (US); Jeffrey H. Price, San Diego, CA (US); Casey Andrew Laris, Solana Beach, CA (US); Lam K. Nguyen, Corona, CA (US); Susanne Heynen, Carlsbad, CA (US); Alexander Nauenberg, La Jolla, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 10/005,342

(22) Filed: Nov. 8, 2001

Related U.S. Application Data
(60) Provisional application No. 60/247,511, filed on Nov. 9, 2000.

(51) Int. Cl. G02B 21/00; G02B 21/26

(52) U.S. Cl. 359/394; 359/391; 359/368; 359/393

(57) ABSTRACT

A sample holder for use with a system for imaging a sample is disclosed. The sample holder includes a stage contact member for contacting with a stage. A sample holding member holds the sample to be imaged by the system. One or more adjustment mechanisms can be used to adjusting the position of the sample holding member relative to the stage.

### RELATED APPLICATION

This application claims the benefit of U.S. Provisional Application No. 60/247,511, filed Nov. 9, 2000 and entitled “SAMPLE HOLDER FOR AN IMAGING SYSTEM,” which is incorporated herein in its entirety.

### STATEMENT REGARDING GOVERNMENTAL RIGHTS

This invention was made with support from the United States Government under Grant No. BES-9871365 awarded by the National Science Foundation. The Government has certain rights in the invention.

### BACKGROUND

1. Field of the Invention

The invention relates generally to systems for imaging a sample. In particular, the invention relates to components for holding the sample to be imaged.

2. Background of the Invention

Images of biological samples can be a useful tool in diagnosing a variety of pathological conditions. For instance, an image of a biological tissue which shows a large number of cells dividing can indicate a cancerous tissue.

These images are often generated by scanning the sample past an imaging devices such as a line scan camera or an area scan camera. During these scans the sample is retained on a sample support such as a slide. The sample support is attached to a stage which is moved relative to the imaging device.

These sample supports are often positioned on the stage so that all or a part of the sample is tilted relative to the stage scan direction. This tilting can result from flaws in the sample support and/or warping of the sample support. Additionally, the tilt can also result from deformations in the stage or inconsistent placement of the sample support on the stage.

The imaging device should be focussed on the sample as the sample is scanned. However, the tilt described above can cause the imaging device to become out of focus as the sample is scanned or can increase the demands on a system employing autofocus. In severe cases, the tilt may be so severe that the imaging device is capable of focussing on one portion of the sample but unable to focus on another portion of the sample.

For the above reasons, there is a need for system of imaging a sample which can account and/or correct for tilt of the sample relative to the scan direction.

### SUMMARY OF THE INVENTION

The invention relates to a sample holder for use with a system for imaging a sample. The sample holder includes a stage contact member configured to be supported by a stage. A sample holding member holds the sample to be imaged by the system. One or more adjustment mechanisms can be used to adjusting the position of the sample holding member relative to the stage.

Another embodiment of the invention relates to a system for imaging a sample. The imaging system includes a stage. A sample holding member holds the sample on the stage. One or more adjustment mechanisms can be used to adjust the position of the sample holding member relative to the stage.

The system can also include electronics for operating the system such that an imaging device views at least two different regions of a sample being held by the sample holding member; and electronics for adjusting at least one adjustment mechanism such that the imaging device is focussed on each of the at least two different regions.

The invention also relates to a method of operating a system for imaging a sample. The method includes operating the system such that an imaging device views at least two different regions of a sample holding member on a stage. The method also includes adjusting at least one adjustment mechanism such that the imaging device is focussed on each of the at least two different regions. The at least one adjustment mechanism adjusts the position of the sample holder relative to the stage.

In one embodiment of the invention the system is operated such that the imaging device views at least two different regions of a sample being held by the sample holding member. The at least one adjustment mechanism is adjusted such that the imaging device is focussed on each of the at least two different regions.

### BRIEF DESCRIPTION OF THE DRAWINGS

FIG. 1 illustrates a system for imaging a sample.

FIGS. 2A and 2B illustrate the effects of tilting the sample relative to the scanning direction of the sample.

FIG. 3A is a top view of a stage for supporting a sample without a sample holder in place.

FIG. 3B is a top view of the stage with the sample holder in place.

FIG. 3C is a cross section of the stage with the sample holder in place.

FIG. 4A is a cross section of a sample holder.

FIG. 4B is a perspective view of the sample holder.

FIG. 5 illustrates an embodiment of a sample holder where gravity pulls a sample holding member toward a stage contact member.

FIGS. 6A and 6B illustrate how the adjustment mechanisms of a sample holder can be used to adjust the tilt of a sample holder.

FIG. 7A is a top view of a stage having a horizontal restraint mechanism. The sample holder is not in place on the stage.

FIG. 7B is a top view of the stage in FIG. 7A with the sample holder in position on the stage.

FIG. 8 is a sideview of a sample holder having a stage contact member that is integral with the stage.

FIG. 9 is a perspective view of a sample holder holding a slide.

FIG. 10A is a perspective view of a sample holder configured to hold a well plate. The well plate is not in position on the sample holder.

FIG. 10B illustrates the sample holder of FIG. 10A with the well plate in place on the sample holder.

FIG. 10C is a cross section of a sample holder holding a well plate.

FIGS. 11A-11C illustrate two support retainers positioned on sides of a sample holder.

FIG. 12 is a perspective view of a sample holder having actuators for electronically adjusting the adjustment mechanisms.

FIG. 13 illustrates a possible arrangement for regions to be viewed by the imaging device.

### DETAILED DESCRIPTION OF THE PREFERRED EMBODIMENT

The present invention relates to a sample holder which is mounted on the stage of a system for imaging a sample. The sample holder includes a sample holding member that supports the sample. The sample holder also includes one or more adjustment mechanisms for adjusting the position of the sample holding member relative to the stage. In particular, the one or more adjustment mechanisms can be used to adjust the tilt of the sample holding member relative to the stage. The adjustment mechanisms are used to adjust the position of the sample holding member such that the sample remains substantially in focus during a scan of the sample.

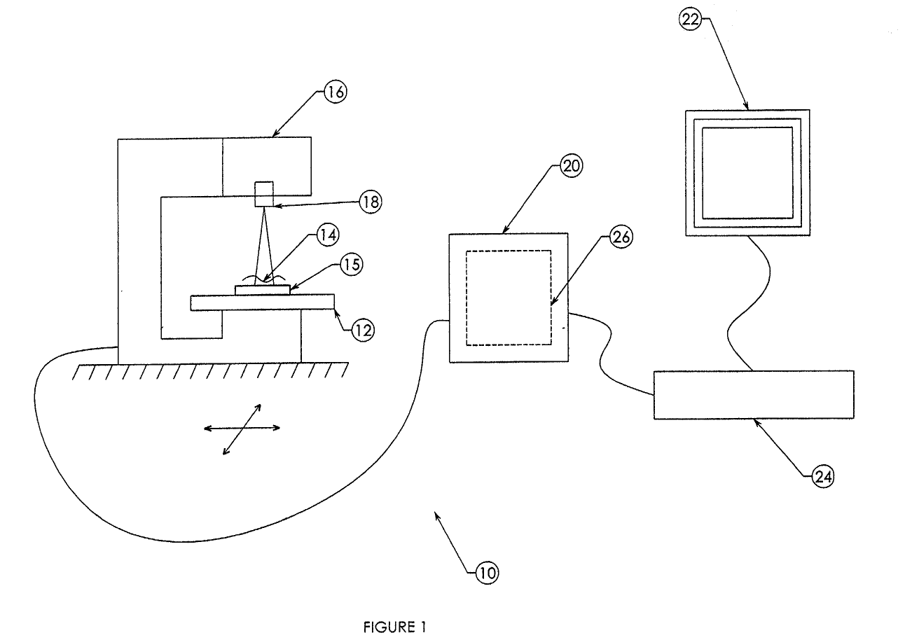

FIG. 1 illustrates a system 10 for imaging and/or viewing of a biological sample 14. The system 10 includes a stage 12 where a sample 14 is positioned in a sample holder 15. An imaging device 16 views the sample 14 through an optical component 18. The imaging device 16 is configured to generate an image of the sample 14. The sample 14 can be scanned by moving the stage 12 relative to the optical component 18. Moving the stage 12 relative to the optical component 18 can include moving the stage 12 while holding the optical component 18 stationary or moving the optical component 18 while holding the stage 12 stationary. Suitable imaging devices 16 include, but are not limited to, area cameras and line scan cameras. Suitable optical components 18 include, but are not limited to, one or more lenses, an aperture through which the imaging device 16 views the sample 14 and or light tubes such as optical fibers. Certain embodiments of the optical component 18, such as lens assemblies, control the location of the focal plane of the imaging device 16 such that the imaging device 16 is focused at a particular height relative to the sample and can be focussed at a depth within the sample 14. When the optical assembly includes a light tube such as a fiber optic the imaging device 16 need not be positioned over the stage 12 as illustrated. For instance, the imaging device 16 can be remotely positioned. A scan which included moving the optical component 18 while holding the stage 12 stationary could be performed by moving only on end of the light tube relative to the stage 12.

The system 10 also includes a processing unit 20 in communication with the imaging device 16, a display 22 and one or more user interfaces 24. The processing unit 20 houses electronics 26 for controlling various operations of the system 10. For instance, the electronics 26 can control movement of the stage 12 relative to the imaging device 16. The display 22 can be used to show at least a portion of one or more sample images that have been generated by the system 10. The displayed image is visible in a display area. The display 22 can also be used to indicate a variety of system 10 conditions to an operator.

An operator can use the one or more user interfaces 24 to interact with the system 10 and vary system parameters. A suitable user interface 24 includes, but is not limited to, a keyboard and a mouse. Although a single processing unit 20, one or more user interfaces 24 and display 22 are illustrated, the system 10 can include a plurality of processing units 20, displays 22 and user interfaces 24.

The electronics 26 can include one or more processors for performing instructions stored or carried on a machine readable medium. Suitable processors include, but are not limited to, programmed general purpose digital computers, microprocessors, digital signal processors (DSP), integrated circuits, application specific integrated circuits (ASICs), logic gate arrays and switching arrays.

Suitable machine readable media include, but are not limited to, RAM, disk drives, optical discs such as a compact disk (CD), CD-ROM, CD-R (a recordable CD-ROM that can be read on a CD-ROM drive), CD-RW (multiple-write CD), CD-E (recordable and erasable CD), or DVD (digital video disc). Alternatively, instead of, or in addition to an optical disc, the machine readable media can include one or more of the following: a magnetic data storage diskette (floppy disk), a Zip disk, DASD storage (e.g., a conventional “hard drive” or a RAID array), magnetic tape, RAM, electronic read-only memory (e.g., ROM, EPROM, or EEPROM), paper punch cards, or transmission media such as digital and/or analog communication links. In some instances, one or more of the machine readable media are positioned outside or remote from the processing unit 20. For instance, the machine readable medium may be part of, or may be connected to, a server computer that is connected to a network, in order to make the machine-readable code available to other computers.

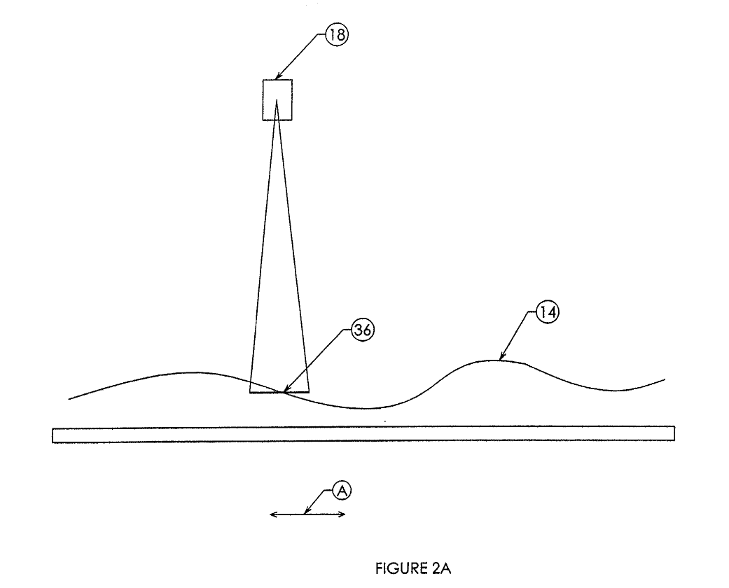

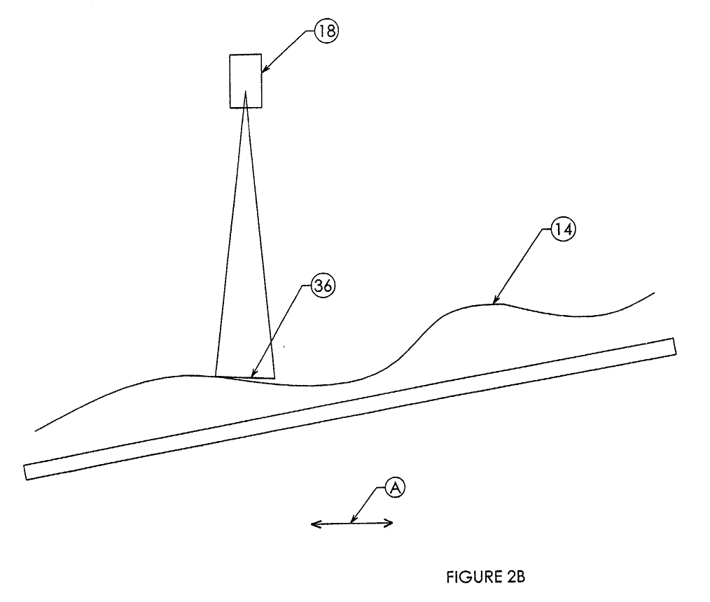

FIG. 2A illustrates an imaging device 16 focussed on a sample 14. The scan is performed in the direction illustrated by the arrow labeled A. The sample 14 is substantially parallel to the scan direction. As a result, the imaging device 16 can retain focus on the sample 14 as the sample 14 is scanned. FIG. 2B illustrates the sample 14 positioned such that the sample 14 is tilted relative to the scanning direction. As the sample 14 is scanned in either direction illustrated by the arrow labeled A, the focal plane 36 is no longer positioned on the sample 14. As a result, the imaging device 16 needs to be re-focussed during the scan. As described above, the present invention relates to methods and apparatuses for remedying the tilt of the sample 14 relative to a focal plane 36 of the imaging device 16.

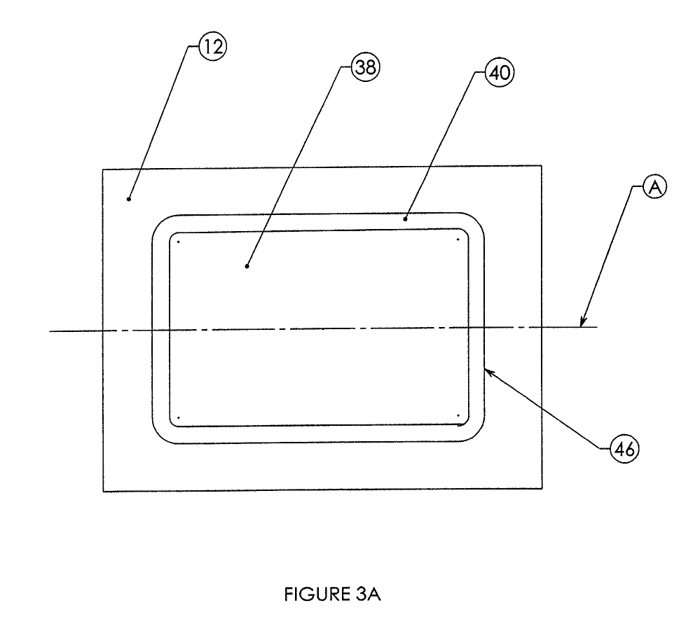

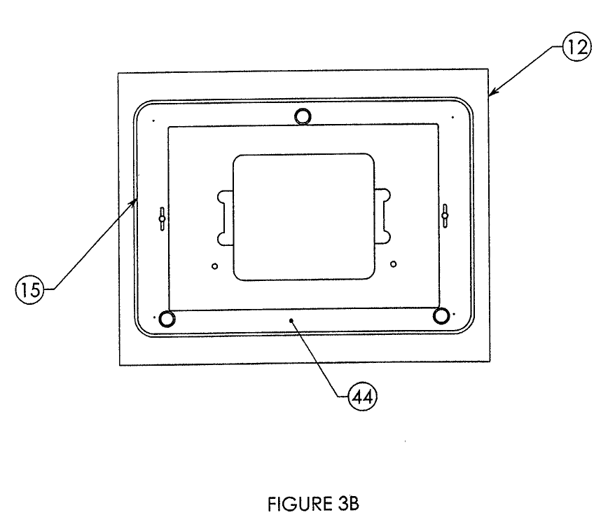

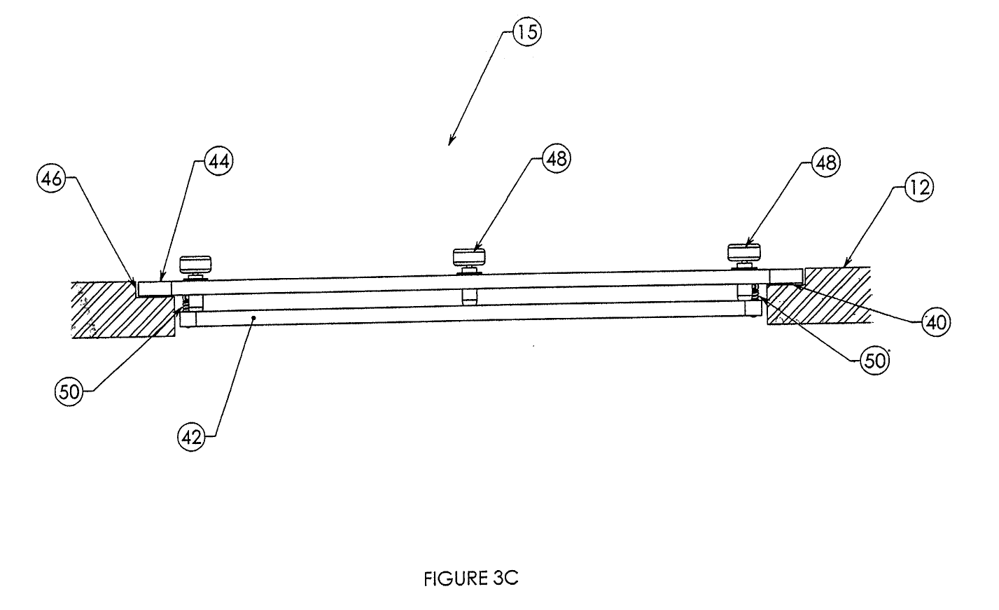

FIGS. 3A, 3B and 3C illustrate the relationship between the stage 12 and the sample holder 15. FIG. 3A is a top view of a stage 12 without the sample holder 15 in place. FIG. 3B is a top view of a stage 12 with the sample holder 15 in place. FIG. 3C illustrates a cross section of the stage 12 taken along the line labeled A in FIG. 3A. The stage 12 includes an opening 38 adjacent to one or more recesses 40. The sample holder 15 includes a sample holding member 42 sized to fit within or pass through the opening 38 and a stage contact member 44 sized to be received within the recess 40. The sides 46 of the recess 40 serve to restrain the horizontal movement of the sample holder 15 on the stage 12. The stage 12 supports the stage contact member 44 of the sample holder 15.

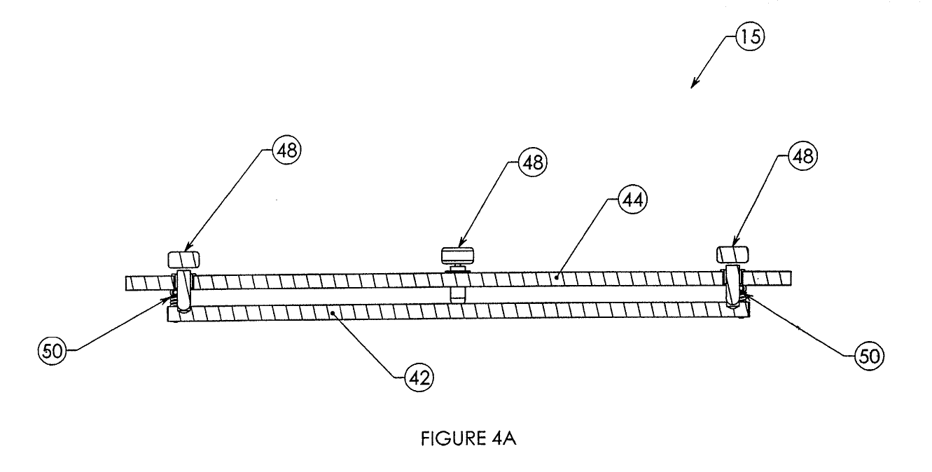

FIGS. 4A illustrates a cross section of a sample holder 15 and FIG. 4B illustrates a perspective view of the sample holder 15. The sample holder 15 includes one or more adjustment mechanisms 48. Each adjustment mechanism 48 keeps the sample holding member 42 and the stage contact member 44 at a particular displacement. Suitable adjustment mechanisms 48 include, but are not limited to, threaded instruments such as screws and micrometers. The adjustment mechanisms 48 illustrated in FIG. 4A are micrometers. The micrometers are screwed into the stage contact member 44 such that the tip of each micrometer contacts the sample holding member 42.

The sample holder 15 includes one or more contraction mechanisms 50 that pull the stage contact member 44 and the sample holding member 42 together. The contraction mechanisms 50 serve to keep the stage contact member 44 in contact with the adjustment mechanisms 48. Suitable contraction mechanisms 50 include, but are not limited to, springs, rubber bands, elastic bands, surgical tubing and other stretchable materials with a memory.

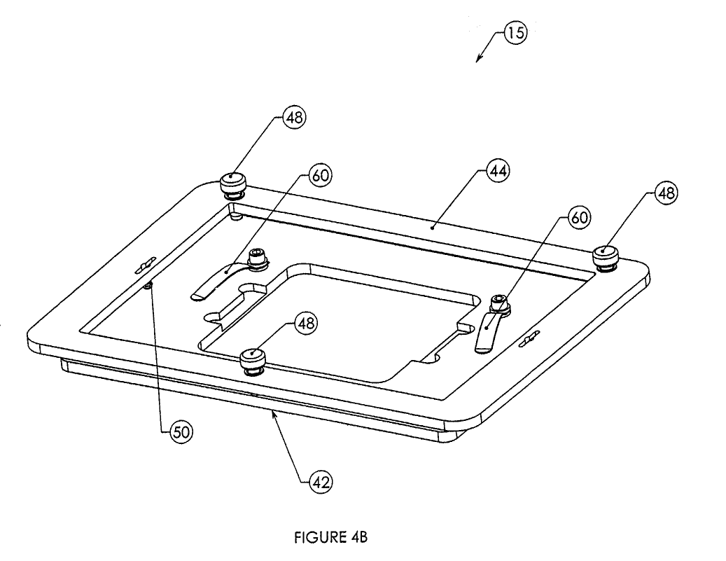

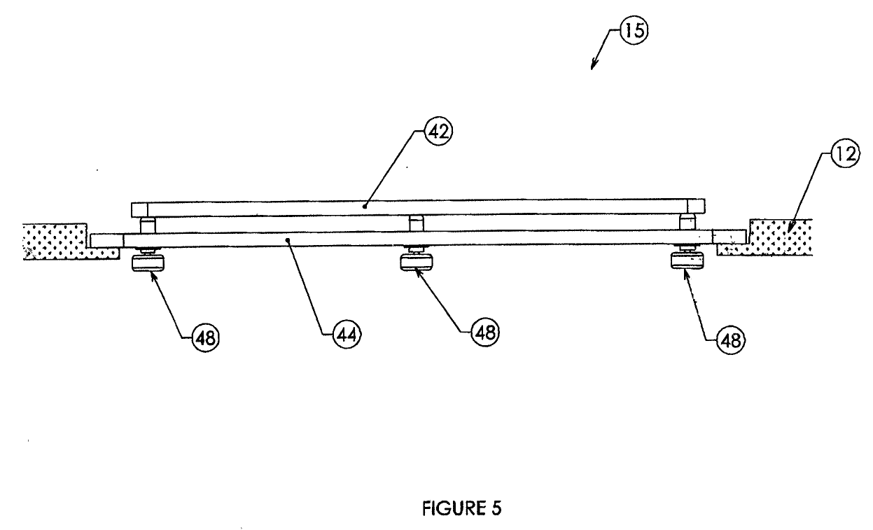

FIG. 5 illustrates an embodiment of the sample holder 15 that does not require contraction mechanisms 50. The sample holder 15 illustrated in FIG. 5 is positioned on the stage 12 with the sample holding member 42 positioned over the stage contact member 44. Accordingly, the sample holding member 42 rests on the adjustment mechanisms 48 and gravity keeps the sample holding member 42 in contact with the adjustment mechanisms 48. The sample holder 15 can optionally include one or more guides to reduce lateral movement of the sample holding member 42 relative to the stage contact member 44.

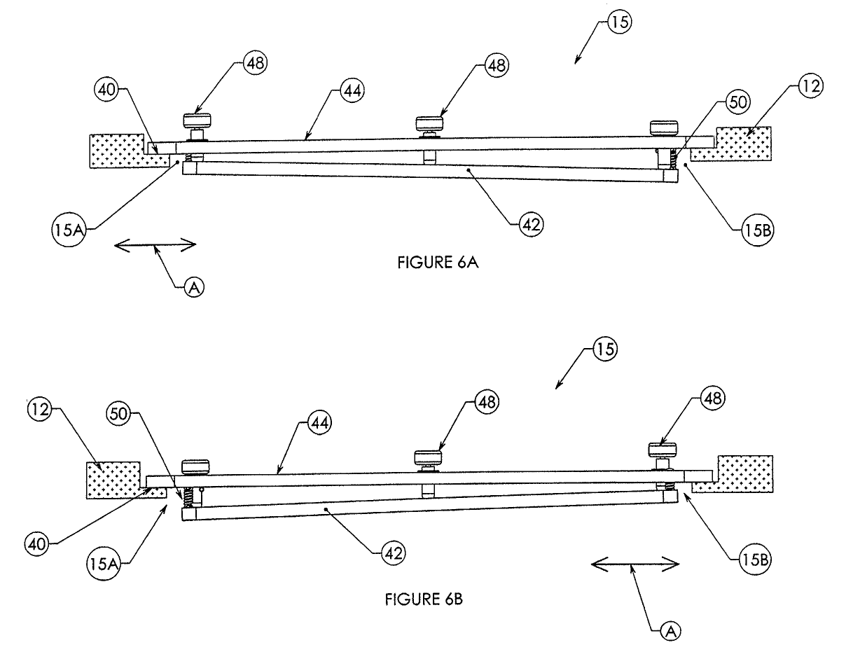

Each adjustment mechanism 48 can be manipulated to adjust the position of the sample holding relative to the stage 12. As described above, each adjustment mechanism 48 is responsible for a particular amount of displacement between the stage contact member 44 and the sample holding member 42. Each adjustment mechanism 48 can be adjusted to change the displacement that results from a particular adjustment mechanism 48. For instance, FIG. 6A illustrates the adjustment mechanisms 48 adjusted such that the displacement between the stage contact member 44 and the sample holding mechanism is smaller on the left side 15A of the sample holder 15 than the right side 15B of the sample holder 15. As a result, the sample holding member 42 is tilted relative to the scan direction illustrated by the arrow labeled A.

Screwing the left adjustment mechanism 48 further into the stage contact member 44 drives the tip of the left adjustment mechanism 48 toward the sample holding member 42. Accordingly, the displacement between the stage contact member 44 and the sample holding member 42 increases on the left side 15A of the sample holder 15 as illustrated in FIG. 6B. Screwing the right separation member out of the stage contact member 44 pulls the tip of the right separation member away from the sample holding member 42. The contraction mechanism 50 pulls the sample holding member 42 toward the stage contact member 44 causing the displacement between the stage contact member 44 and the sample holding member 42 to decrease on the right side 15B of the sample holder 15. Each of the adjustment mechanisms 48 can be adjusted to bring the sample holding member 42 substantially parallel to the scan direction. Accordingly, the imaging device 16 is more likely to remain focussed on the sample 14 as the stage 12 is moved relative to the imaging device 16.

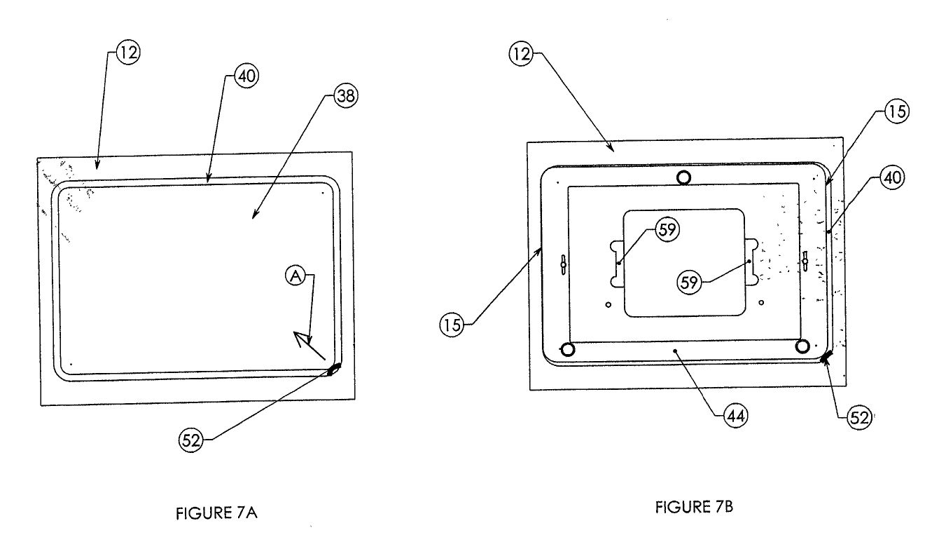

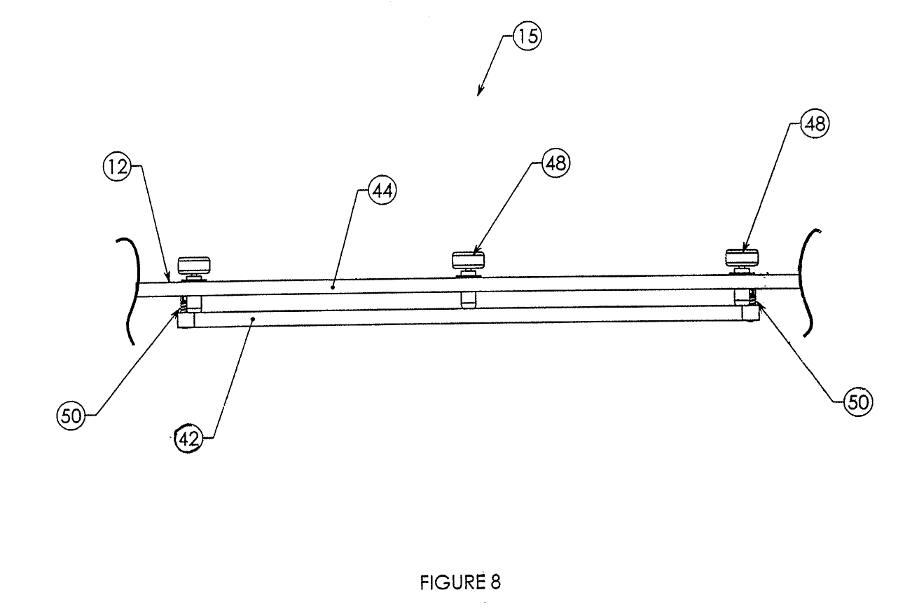

As illustrated in FIGS. 7A and 7B, the stage 12 can include a horizontal restraint mechanism 52. FIG. 7A is a top view of the stage 12 without the sample holder 15 in position on the stage 12 and FIG. 7B is a top view of the stage 12 with the sample 14 in position on the stage 12. A spring loaded button serves as the horizontal restraint mechanism 52. The spring loaded button extends into the holder retention region from a side 46 of the recess 40. The spring loaded button can be physically moved toward the side 46 of the recess 40, however, the spring drives the button in the direction of the arrow. When the sample holder 15 is placed on the stage 12, the stage contact member 44 pushes the button toward the side 46. The force from the spring drives the sample holder 15 toward the side 46 of the recess 40. As a result, the horizontal restraint mechanism 52 restrains the horizontal movement of the sample holder 15.

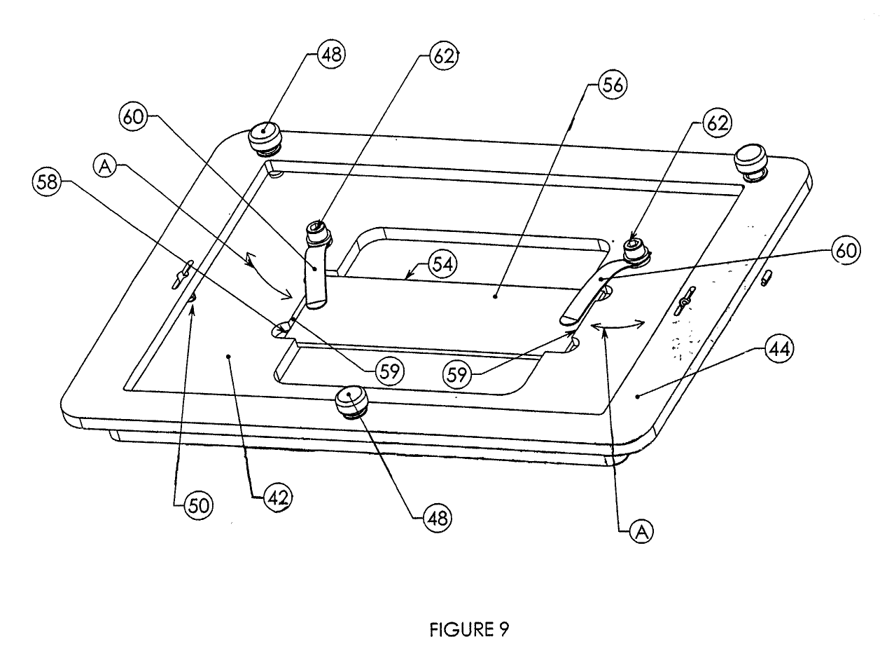

The sample holder 15 can be integral with the stage 12 as illustrated in FIG. 8. The stage contact member 44 is permanently connected to the stage contact member 44 so the sample holder 15 can not be removed from the stage 12. In this embodiment, the stage 12 can serve as the stage contact member 44 or the stage contact member 44 can serve as the stage 12.

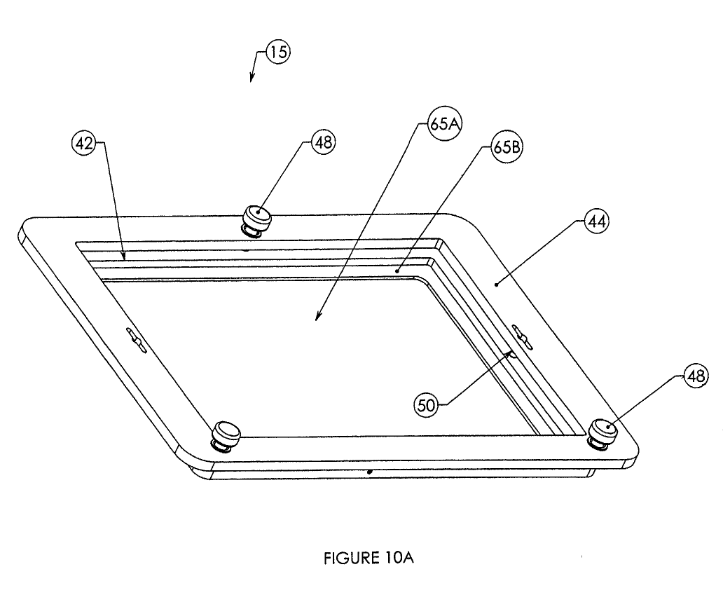

As described above, the sample holding member 42 serves to hold the sample 14 to be imaged. The sample holding member 42 can include a sample support 54 that supports the sample 14 to be imaged. The sample holding member 42 can include a variety of sample supports 54 including, but not limited to, microscope slides, coverslips, single well or multiwell tissue culture plates, tissue culture chambers, tissue section holders, fixed or live tissue holders, animal holders with or without window chambers, integrated circuit holders and holders for wafer inspection. FIG. 9 illustrates the sample holder 15 of FIG. 4A holding a slide 56. The slide 56 typically includes one or more transparent pieces. The sample 14 is positioned on top of or between the transparent pieces.

The ends 58 of the slide 56 are positioned in a recess 59 in the sample holding member 42. The sampling holding member includes one or more sample support retainers 60. The sample support retainers 60 can be rotated around a fastener 62 as illustrated by the arrows labeled A. Once the ends 58 of the slide 56 are positioned in the recesses 59, the sample support retainers 60 are moved over the slide 56 as shown in FIG. 9. The sample support retainers 60 can be constructed from a flexible material such as metal or plastic. Additionally, the sample support retainers 60 can be shaped so they apply a downward pressure to the slide 56 when they are positioned over the slide 56. As a result, the sample support retainers 60 help to immobilize the slide 56 relative to the sample holding member 42.

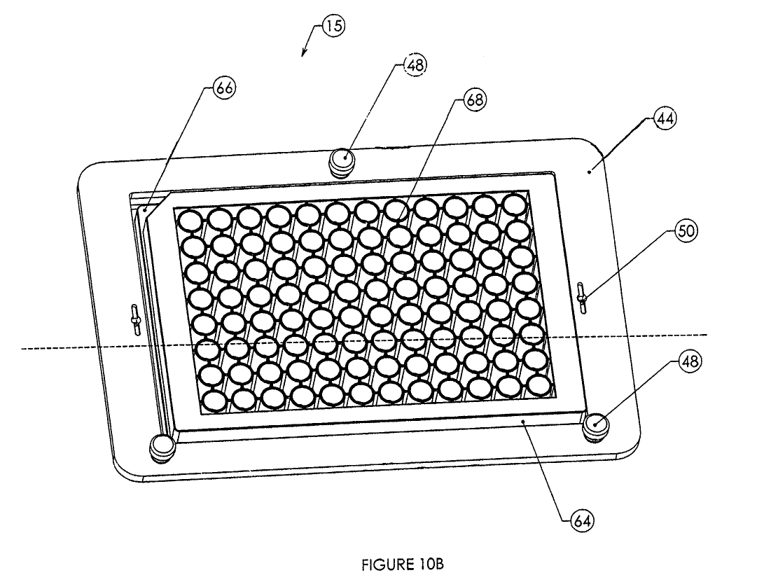

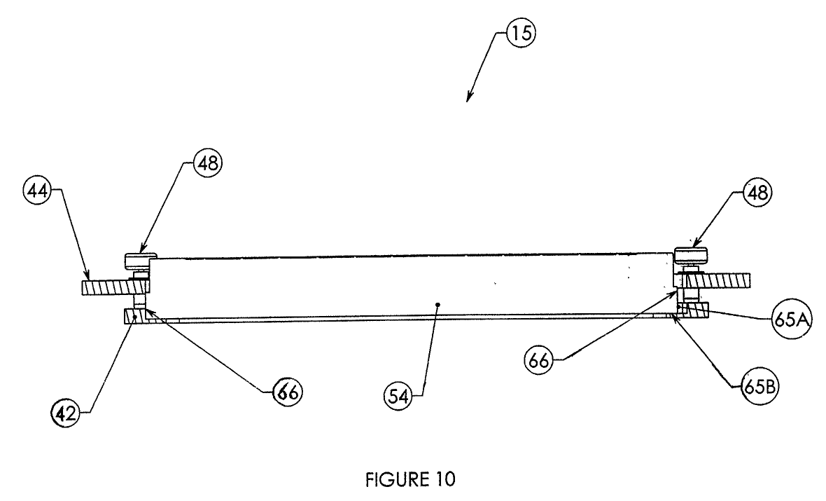

FIGS. 10A, 10B and 10C illustrate a sample holder 15 having a sample holding member 42 shaped to hold a well plate 64. FIG. 10A is a perspective view of the sample holder 15 without the well plate 64. FIG. 10B is a perspective view of the sample holder 15 holding the well plate 64. FIG. 10C is a cross sectional view of the sample holder 15 of FIG. 10B taken along the line labeled A in FIG. 10B.

The sample holding member 42 includes an opening 65A adjacent to a recess 65B. The well plate 64 has a flange 66 extending outward from a well region 68. The well region 68 includes one or more wells where are placed for imaging. The well region 68 is sized to pass through or fit within the opening 65A. The flange 66 is sized to be received within the recess 65B such that the flange 66 rests on the sample holding member 42. Accordingly, the sample holding member 42 supports the well plate 64. Although not illustrated, the sample holding member 42 can include one or more sample support retainers 60 for immobilizing the well plate 64 relative to the sample holding member 42. Suitable sample support retainers are discussed with respect to FIG. 4B.

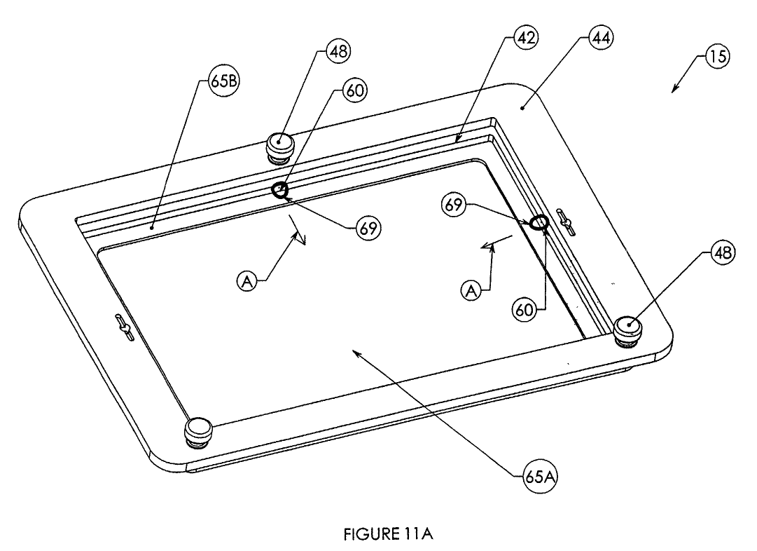

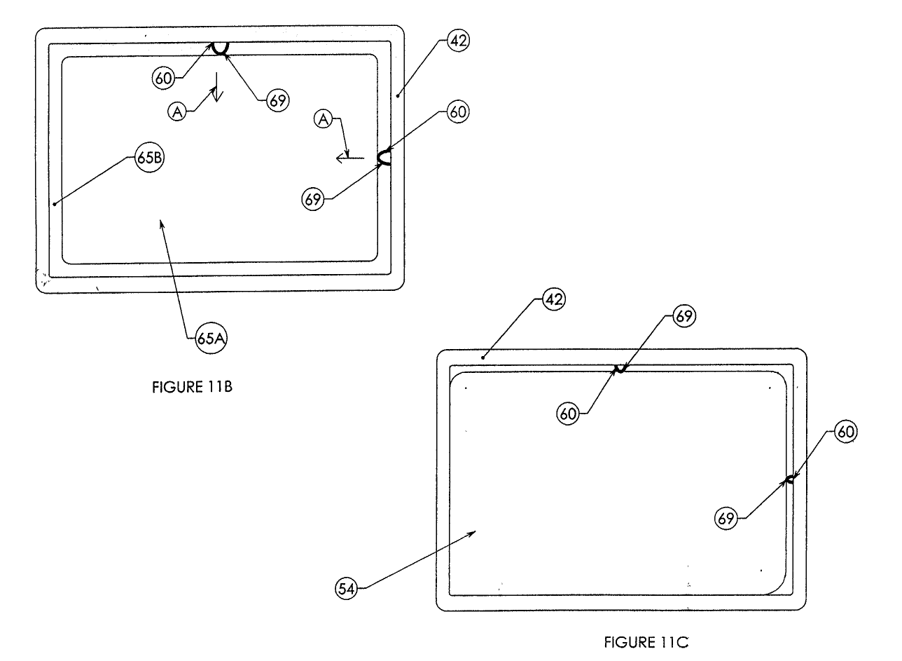

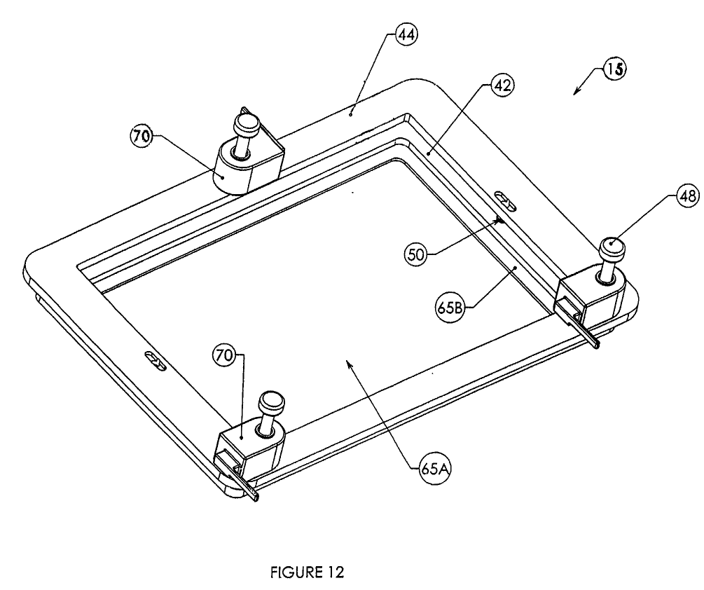

FIGS. 11A, 11B and 11C illustrate another example of a sample support retainer 60. FIG. 11A is a perspective view of the sample holder 15 including two sample support retainers 60 and FIG. 11B is a top view of the sample holding member 42 including two sample support retainers 60. The sample support retainers 60 include a retention member 69 extending from a side the sample holding member 42. The retention member 69 can be pushed in toward the side of the sample holding member 42 and is biased in the direction of the arrows labeled A. Suitable mechanisms for providing the bias include, but are not limited to, a spring. The retention members are sized so that a sample support 54 positioned on the sample holding member 42 pushes the retention member 69 into the side of the sample holding member 42 as illustrated in FIG. 11C. The bias on each retention member 69 drives the sample support 54 toward a side of the sample support member 42 as illustrated in FIG. 11C. Accordingly, the sample support retainers 60 reduce the mobility of the sample support 54 relative to the sample holding member 42.

Although FIGS. 11A-11C illustrate two sample support retainers 60 positioned along the sides of the sample holding member, the sample holder 15 can include a single sample support retainer 60. For instance, a single sample support retainer 60 can be positioned in a corner of the sample holding member 42. Additionally, the sample holder 15 can include more than two sample support retainers 60. Further, sample support retainers 60 of FIGS. 11A-11C can be used in conjunction with the sample support retainers 60 illustrated in FIG. 4B.

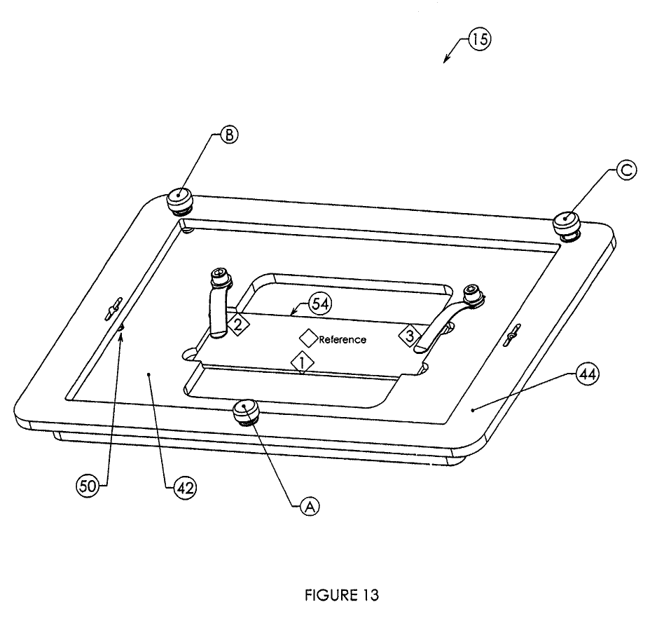

The adjustment mechanisms 48 can be controlled by the electronics 26. For instance, each of the adjustment mechanisms 48 can be coupled to an actuator 70 as illustrated in FIG. 12. An example of an actuator that can be coupled with a micrometer is a micromotor. The electronics 26 can adjust the adjustment mechanisms 48 to achieve the desired position of the sample holding member 42 relative to the stage contact member 44. Other examples of adjustment mechanisms that can be controlled by the electronics include, but are not limited to, voice coil actuators and linear actuators positioned to act between the stage contact member 44 and the sample holding member 42.

The system 10 is operated to increase the opportunity for the sample 14 to remain in focus during a scan of the sample 14. The stage 12 is moved relative to the optical component 18 such that the imaging device 16 views at least two different regions of the sample holding member 42. In one embodiment, the stage 12 is moved so the imaging device 16 views at least two different regions of a sample 14 held by the sample holder 15 as illustrated in FIG. 13. When the imaging device 16 is viewing each region, the adjustment mechanisms 48 are adjusted so the sample 14 is in focus. This series of steps can be performed until the desired degree of focus is achieved at each region without further changing the adjustment mechanisms 48. The scan of the sample 14 can then be performed.

FIG. 13 illustrates a possible arrangement for regions to be viewed by the imaging device. The stage 12 is moved so the imaging device 16 views the region labeled “reference” and the imaging device 16 is focussed on the sample 14. The imaging device 16 can be focussed on the sample 14 by adjusting the optical component 18. The stage 12 is then moved so the imaging device 16 views the region labeled 1. The adjustment mechanism 48 labeled A is adjusted until the sample 14 is in focus. The stage 12 is then moved so the imaging device 16 views the region labeled 2. The adjustment mechanism 48 labeled B is adjusted until the sample 14 is in focus. The stage 12 is then moved so the imaging device 16 views the region labeled 3. The adjustment mechanism 48 labeled C is adjusted until the sample 14 is in focus. This sequence of steps can be repeated for the regions labeled 1, 2 and 3 until each of the regions does not require adjustment to achieve a desirable focus. Other numbers and patterns of regions are also possible for use with the methods of the present invention.

The stage 12 can also be moved relative to the optical component 18 so the imaging device 16 views a large number of regions on the sample holding member 42 or on a sample 14 held by the sample holding member 42. The degree of focus at each region can be determined and can be used to approximate the position of the sample 14 relative to the scan direction (or the stage 12). The approximated position can be used to adjust the adjustment mechanisms 48.

The above methods can also be performed by choosing regions that are located on the sample holding member 42. This provides the additional advantage of being able to increase the distance between each of the regions. Additionally, the regions can be marked on the sample holding member 42. When the regions are located on the sample holding member 42, the imaging device 16 is focussed on the sample 14 before the scan.

One embodiment of the system also performs autofocus. Examples of systems that include autofocus include U.S. Pat. No. 5,790,710, U.S. Pat. No. 5,932,872 and U.S. Pat. No. 5,995,143 which are each incorporated herein by reference in their entirety. Embodiments with autofocus often have a narrow focus range. For instance, systems employing a fast piezoeletric focussing element can have autofocus within 0.1-0.2 seconds with a focus range of 100-350 μm. Because the autofocus range is so narrow, areas of the sample easily fall outside the range of focus. For instance, effects such as tilt, warp in the sample holder, warp in the sample support and varying sample surface contour as is illustrated in FIG. 2 can act independently or together to move areas of the sample outside the range of focus.

The autofocus can be operated in conjunction with the adjustment mechanisms to keep the sample in focus during the scan. In one embodiment, the sample is divided into sub-areas. The autofocus and the above method for adjusting the adjustment mechanisms is sequentially performed on each sub-area. For instance, the regions used to set the adjustment mechanisms are selected to be positioned within a particular sub-area. Before the sub-area is scanned, the adjustment mechanisms are adjusted to keep the sub-area of the sample substantially parallel to the scan direction and within the range of focus of the system. Because the sub-area is smaller than the entire sample, the effects of tilt or warp are reduced. Accordingly, the autofocus is more likely to be able to retains focus on the sample within the sub-region. The process is then repeated for another sub-area.

In another embodiment, the adjustment mechanisms are controlled by the electronics. The electronics are programmed to adjust the adjustment mechanisms such that the portion of the sample being scanned is substantially parallel with the scan direction and within the range of focus. A preliminary scan is performed to identify the locations of highs and lows on the sample. As the high points and/or low points are being approached during the final scan of the sample, the adjustment mechanisms are adjusted to bring the sample within the focus range. Alternatively, the preliminary scan is not performed and the adjustment mechanisms are adjusted during the scan to compensate for the variations in the sample. For instance, when the focussing element is nearing the point of the focus range where the focussing element is nearest the sample, the adjustment mechanisms can raise the viewed portion of the sample toward the focussing element. Accordingly, the focussing element can return to the middle of the focus range while retaining focus on the sample. The machine readable medium can include instructions for performing the above methods.

As noted above, moving the stage 12 relative to the imaging device 16 can be accomplished by holding the optical component 18 stationary while moving the stage 12, by moving the optical component 18 while holding the stage 12 stationary or by moving both in different directions or different speeds.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

What is claimed is:

1. A sample holder for use with a system for imaging a sample, comprising:
a stage contact member for contacting with a stage;
a sample holding member for holding the sample to be imaged by the system; and
one or more adjustment mechanisms for adjusting the position of the sample holding member relative to the stage.

2. The sample holder of claim 1, wherein each adjustment mechanism controls the degree of separation between the sample holding member and the stage contact member.

3. The sample holder of claim 1, wherein the sample holder is removable from the stage.

4. The sample holder of claim 1, wherein the stage contact member is sized to be received in a recess in the stage.

5. The sample holder of claim 1, wherein the sample holding member is sized to fit within a hole in the stage.

6. The sample holder of claim 1, wherein the one or more adjustment mechanisms include a micrometer threaded through the stage contact member.

7. The sample holder of claim 1, wherein the one or more adjustment mechanisms include an actuator for electronically adjusting the position of the sample holding member relative to the stage.

8. The sample holder of claim 1, further comprising:
one or more contraction mechanisms that pull the stage contact member and the sample holding member together.

9. The sample holder of claim 1, wherein the sample holding member is configured to hold a sample support which supports the sample.

10. The sample holder of claim 9, wherein the sample support is a slide.

11. The sample holder of claim 9, wherein the sample support is a well plate.

12. The sample holder of claim 1, wherein the sample holding member includes one or more sample support retainers.

13. The sample holder of claim 1, wherein the adjustment mechanisms can adjust the tilt of the sample holder.

14. The sample holder of claim 1, wherein the sample holding member includes at least one sample support retainer for stabilizing a sample support relative to the sample support.

15. A system for imaging a sample, comprising:
a stage;
a sample holding member for holding the sample on the stage; and
one or more adjustment mechanisms for adjusting the position of the sample holding member relative to the stage.

16. The system of claim 15, wherein the one or more adjustment mechanisms include a micrometer.

17. The system of claim 15, wherein the one or more adjustment mechanisms include an actuator for electronically adjusting the position of the sample holding member relative to the stage.

18. The system of claim 15, further comprising:
one or more mechanisms that pull the stage and the sample holding member together.

19. The system of claim 15, wherein the sample holding member is configured to hold a sample support which supports the sample.

20. The system of claim 15, wherein each adjustment mechanism controls the degree of separation between the sample holding member and the stage.

21. The system of claim 15, wherein the adjustment mechanisms can adjust the tilt of the sample holding member.

22. The system of claim 15, further comprising:
electronics for adjusting the adjustment mechanisms such that an imaging device viewing a region of the sample holding member is focussed on the sample holding member.

23. The system of claim 15, further comprising:
electronics for adjusting the adjustment mechanisms such that an imaging device viewing a sample held by the sample holding member is focussed on the sample.

24. The system of claim 15, further comprising:
electronics for adjusting the adjustment mechanisms to keep the sample within the focus range of an optics assembly.

25. The system of claim 15, further comprising:
electronics for adjusting the adjustment mechanisms to keep the sample within the focus range of an optics assembly having autofocus.

26. The system of claim 15, further comprising:
electronics for adjusting the adjustment mechanisms and an autofocus so as to keep the sample within a range of focus.

27. The system holder of claim 15, further comprising:
electronics for operating the system such that an imaging device views at least two different regions of the sample holding member; and
electronics for adjusting at least one adjustment mechanism such that the imaging device is focussed on each of the at least two different regions.

28. The system holder of claim 15, further comprising:
electronics for operating the system such that an imaging device views at least two different regions of a sample being held by the sample holding member; and
electronics for adjusting at least one adjustment mechanism such that the imaging device is focussed on each of the at least two different regions.

29. The system of claim 15, wherein the sample holding member includes at least one sample support retainer for stabilizing a sample support relative to the sample support.

30. A method of operating a system for imaging a sample, comprising:
operating the system such that an imaging device views at least two different regions of a sample holding member on a stage; and
adjusting at least one adjustment mechanism such that the imaging device is focussed on each of the at least two different regions, the adjustment mechanism adjusting the position of the sample holder relative to the stage.

31. The method of claim 30, wherein operating the system such that the imaging device views at least two different regions of a sample holding member on a stage includes
operating the system such that the imaging device views at least two different regions of a sample being held by the sample holding member.
